(19) United States
(12) Patent Application Publication
(10) Pub. No.: US 2012/0141087 A1
(43) Pub. Date: Jun. 7, 2012

(54) METHOD AND SYSTEM FOR A SIMPLE USER INTERFACE TO AN ELECTRONIC DEVICE

(75) Inventors: Eric Stephen Carlsgaard, Zionsville, IN (US); James Duane Tenbarge, Fishers, IN (US)

(73) Assignee: SHENZHEN TCL NEW TECHNOLOGY LTD., Shekou, Shenzhen, Guangdong (CN)

(21) Appl. No.: 13/129,176

(22) PCT Filed: Jul. 17, 2009
(86) PCT No.: PCT/US09/51030

§ 371 Date: May 13, 2011

(30) Foreign Application Priority Data
Dec. 15, 2008 (CN) 200810184059.5

(51) Int. Cl. H04N 5/775

(52) U.S. Cl. 386/230; 386/E05.003

(57) ABSTRACT

An electronic device is provided that includes a media subsystem that may include an audio subsystem, a display subsystem, or both. The electronic device additionally includes an interface that is adapted to connect the electronic device to an auxiliary device and a remote receiver that is configured to receive commands from a remote control. The remote control includes a menu button, which may send a menu selection command to the electronic device that may be used to incrementally display menu screens from either the auxiliary device or the electronic device upon subsequent presses.

### BACKGROUND

This section is intended to introduce the reader to various aspects of art which may be related to various aspects of the present techniques that are described below. This discussion is believed to be helpful in providing the reader with background information to facilitate a better understanding of the various aspects of the present techniques. Accordingly, it should be understood that these statements are to be read in this light, and not as admissions of prior art.

Many media devices, such as television sets, are intended to interface with and play media files from auxiliary devices, such as DVD players, CD players, and the like. The media files may include, for example, audio files, video files, and digital still picture files, among others. To facilitate interfacing with the auxiliary devices, the media device may generally have separate inputs for audio signals and video signals. Recently, a new type of interface, called a high-definition multimedia interface, or HDMI, has been developed that combines both audio and video signals in a single cable. This interface may also allow for the transfer of control signals between interconnected devices, using a serial line embedded within the cable called the consumer electronics control channel.

While an HDMI may simplify the interconnections between devices, it may not reduce the complexity of operating the devices. For example, while control signals may be sent from one device to another, the user may still be required to implement a complex sequence of key presses to determine which device will receive the control signals.

### BRIEF DESCRIPTION OF THE DRAWINGS

In the drawings:

FIG. 1 is a perspective drawing of an electronic device connected to an auxiliary device, in accordance with the present techniques;

FIG. 2 is a block diagram of an electronic device connected to an auxiliary device, in accordance with the present techniques;

FIG. 3 is a process flow diagram illustrating a method for powering on an auxiliary device, in accordance with the present techniques;

FIG. 4 is a process flow diagram illustrating a method for selecting and displaying a menu from an auxiliary device on an electronic device, in accordance with the present techniques; and

FIG. 5 is a process flow diagram illustrating a method for generating commands useful for an auxiliary device on an electronic device based on commands received from a remote control, in accordance with the present techniques.

### DETAILED DESCRIPTION

One or more presently contemplated embodiments of the present techniques will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

A presently contemplated embodiment provides an electronic device (for example, a television, a computer system, and the like) that has an interface for connection to auxiliary devices, such as digital video disk (DVD) players, videotape players, digital video recorders, compact disk (CD) players, and the like. The electronic device may have a media subsystem to facilitate the play of media signals, such as an audio subsystem, a video display, or both. Further, the electronic device may have a user interface for analyzing commands received by the electronic device from a remote control, and automatically generating commands to control an auxiliary device from the commands received. The commands may be generated for the auxiliary device if an interface to the auxiliary device has been selected as the input to the electronic device. For example, the interface may utilize a high-definition multimedia interface (HDMI) that uses a single cable to carry audio, video, and /or control signals between the electronic device and the auxiliary device. The remote control includes a menu button, which may send a menu selection command to the electronic device that may be used to incrementally display menu screens from either the auxiliary device or the electronic device upon subsequent presses.

Furthermore, when the interface to the auxiliary device is selected as the input, the electronic device may automatically determine which commands entered by the remote control are relevant to the auxiliary device and which commands should be executed by the electronic device itself. For example, a volume up or volume down command may be implemented by the electronic device. In contrast, a command to play or stop play entered from the remote control may be used by the electronic device to generate an appropriate command for transfer to the auxiliary device through an interface. Further, commands from the remote control such as channel up or channel down may be used by the electronic device itself if an antenna input is selected, but may be used to generate commands to be sent to the auxiliary device, e.g., a cable box adapter, when the interface to the auxiliary device is selected as an input. For example, if the input selected is an HDMI, the electronic device may generate consumer electronic control (CEC) compliant commands to be sent to the electronic device over the CEC channel of the HDMI.

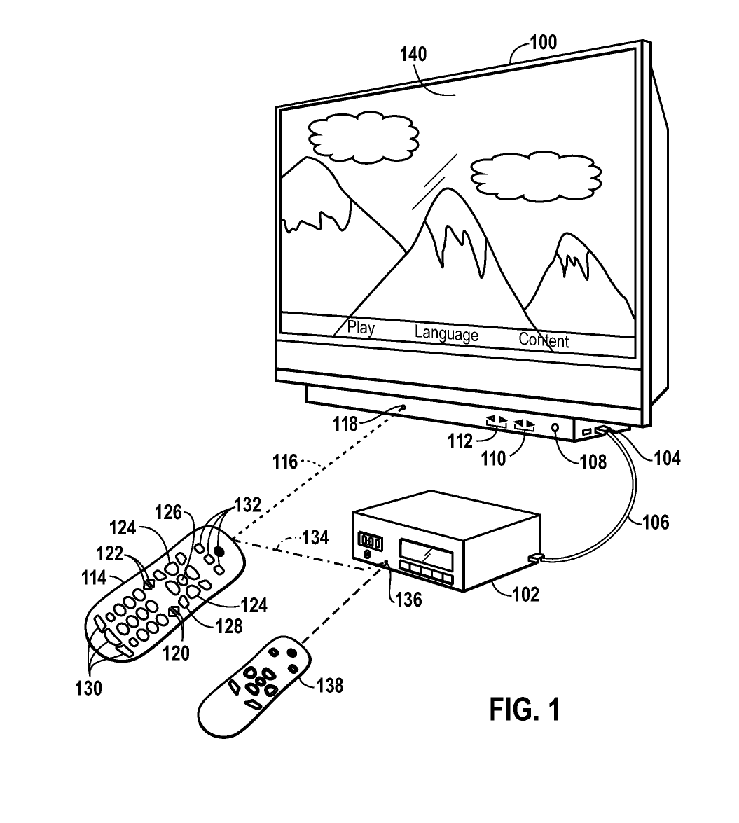

FIG. 1 is a perspective view of an electronic device 100 that may be connected to an auxiliary device 102. In the presently contemplated embodiment illustrated in FIG. 1, the electronic device 100 may be a television and the auxiliary device 102 may be a digital video disk (DVD) player. However, any number of different units may be used for the electronic device 100, including high end audio players, computers, projectors, high-definition television sets, and the like. Further, any number of different units may be used for the auxiliary device 102, including cable box adapters, DVD players, high-definition DVD players, digital video recorders, computers, CD players, and the like. The electronic device 100 may have an interface 104 that may connect to a cable 106 from the auxiliary device 102.

For example, the cable 106 may be an HDMI cable configured to carry digital audio, digital video, and control signals between the electronic device 100 and the auxiliary device 102. However, multiple cables may be used, with one set of cables carrying the audio signals, another set carrying the video signals, and a third set carrying the command signals. Furthermore, other types of interface bus systems may be used, for example, universal serial bus (USB), IEEE 1394 (“Firewire”), Ethernet, and the like.

The electronic device 100 may be controlled by a limited set of buttons on the front panel, including, for example, a power switch 108, channel buttons 110, and volume buttons 112. Additionally, the electronic device 100 may be controlled by a remote control 114. A signal 116 from the remote control 114 may be received by the electronic device 100 through a remote receiver 118 which may be located on the front panel. The remote receiver 118 may be a photodetector for receiving encoded light pulses, an antenna for receiving radio signals, and the like.

The remote control 114 may provide a more extensive set of command selections than may be accessible from the buttons 110, 112 located on the front panel of the electronic device 100. For example, in addition to providing channel control buttons 120 and volume control buttons 122, the remote control 114 may also provide navigation buttons 124 for navigating through a set of menus, a selection button 126 to select an entry, and a menu button 128 to bring up user menus, among others. The remote control 114 may also include auxiliary buttons 130 that may generate commands that may be used by an auxiliary device 102, such as, for example, play, stop, or rewind, among others. The command selections from the remote control 114 are not limited to those discussed above, but may include any number of other commands.

The remote control 114 may also have a device button 132 to select what device the remote control 114 will control, e.g., the electronic device 100 or the auxiliary device 102. The device button 132 may select different pulse sequences, from the remote control 114, which may allow the remote control 114 to send control signals 134 directly to a receiver 136 on the auxiliary device 102. These direct control signals 134 allow the remote control 114 to be used in place of an auxiliary remote control 138. However, to be used in this fashion, the remote control 114 must be programmed to generate the appropriate direct control signals 134 for the auxiliary device 102. Such programming may add more complexity to the use of the electronic device 100 with the auxiliary device 102.

When properly connected to an auxiliary device 102, and upon selection of the appropriate interface 104 as an input to the electronic device 100, the interface cable 106 allows media content 140 from the auxiliary device 102 to be directly displayed on the electronic device 100. The electronic device 100 may generate commands to control the auxiliary device 102 based on the commands entered from the remote control 114 if the interface 104 is selected as the input. These commands may be sent to the auxiliary device 102 via the interface cable 106. This may reduce the need for programming the remote control 114, as the signal 116 from the remote control 114 is always sent to the electronic device 100, which can analyze the command to determine whether to generate a corresponding command for the auxiliary device 102.

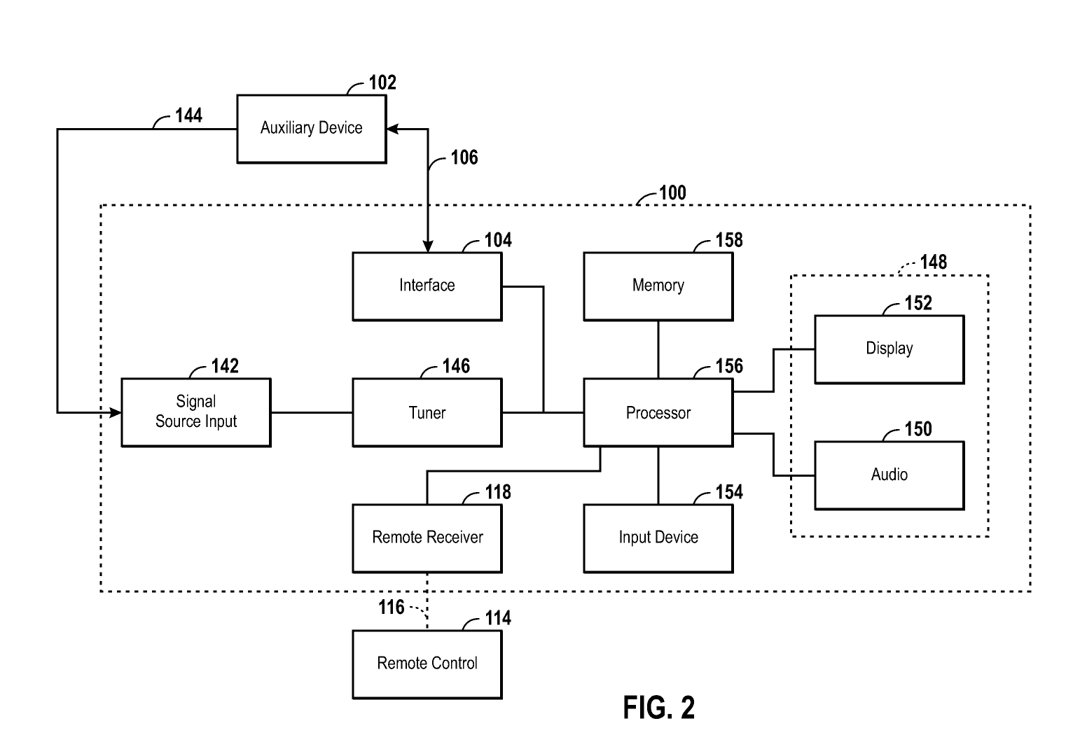

FIG. 2 is a block diagram of the electronic device 100 of FIG. 1 in accordance with a presently contemplated embodiment. The electronic device 100 may include various subsystems represented as functional blocks in FIG. 1. The functional blocks shown in FIG. 1 may include hardware elements (including circuitry), software elements (including computer code stored on a machine-readable medium) or a combination of both hardware and software elements.

The electronic device 100 may have a signal source input 142, which may include an antenna input, an audio input, a video input, an S-video input, a composite video input, a digital video input, or combinations thereof. Although only one signal source input 142 is shown, the electronic device 100 may have multiple signal source inputs. The signal source input 142 may be adapted to receive a signal that comprises video signals and/or audio signals. The signal received by the signal source input 142 may comprise a broadcast spectrum (e.g., if the signal source input 142 comprises an antenna) or a single channel of video and/or audio signal (e.g., if the signal source input 142 is connected to the analog audio and/or video outputs of the auxiliary device 102), as represented by the connection 144.

A tuner subsystem 146 may be adapted to tune a particular video program from a broadcast signal received from the signal input source 142. Input signals that are not received as part of a broadcast spectrum will generally bypass the tuner subsystem 146 as tuning is not required to isolate a video program associated with those signals.

An interface 104 may be selected as the input to the electronic device 100. The interface 104 may include, for example, a high-density multimedia interface (HDMI), a wireless network connection, an Ethernet connection, a Universal Serial Bus (USB) connection, or any other suitable connection that allows the electronic device 100 to communicate with an external unit, such as the auxiliary device 102. As discussed below, the interface 104 may be used for the transfer of command and control information between the electronic device 100 and the auxiliary device 102, for example, commands from the electronic device 100 to the auxiliary device 102, menu information from the auxiliary device 102 to the electronic device 100, and the like. Further, the interface 104 may be used to receive digital media signals from the auxiliary device 102 for play by the electronic device 100. These media signals may comprise digital still pictures, audio signals, or video signals, or any combination thereof, and the media files may be continuously transferred, or streamed, from the auxiliary device 102 during play by the electronic device 100.

The electronic device 100 may include a media subsystem 148, comprising an audio subsystem 150, a display subsystem 152, or both. The audio subsystem 150 may include, for example, an audio amplifier and one or more speakers connected to the audio amplifier and may be adapted to play audio files, including audio files associated with video files being displayed by the electronic device 100. The display subsystem 152 may include, for example, a plasma display, a liquid crystal (LCD) display, a liquid-crystal-on-silicon (LCOS) display, a digital light projection (DLP) display, a cathode-ray tube display, or any other suitable display type. The display subsystem 152 may also include a lighting source (not shown) that is used to generate a visible image on the display.

An input device 154 may be used to enter user data into the electronic device 100. The input device 154 may include, for example, buttons 110, 112 on the front panel of the electronic device 100, a keypad on the front of the electronic device 100, or the like. As discussed with respect to FIG. 1, the electronic device 100 may also have a remote receiver 118 configured to receive a signal 116 from a remote control 114. The input device 154, or the remote control 114, and the media subsystem 148 together may be used in a user interface for the entry of commands for the control of the electronic device 100, the auxiliary device 102, or both. For example, the user interface may be used to instruct the electronic device 100 to play specific media files stored on the auxiliary device 102. Further, the user may display menus from the auxiliary device 102 on the display subsystem 152 of the electronic device 100.

A processor 156 may be configured to control the overall operation of the electronic device 100, including the decoding of digital audio or video signals transferred from the auxiliary device 102. A memory 158, which may include read only memory (ROM), may be associated with the processor 156 to hold machine-readable computer code that causes the processor 156 to control the operation of the electronic device 100. The memory 158 may also include random access memory (RAM) to be used for storage of temporary information, including, for example, menu information for the auxiliary device 102, such as content menus, set-up menus, and the like.

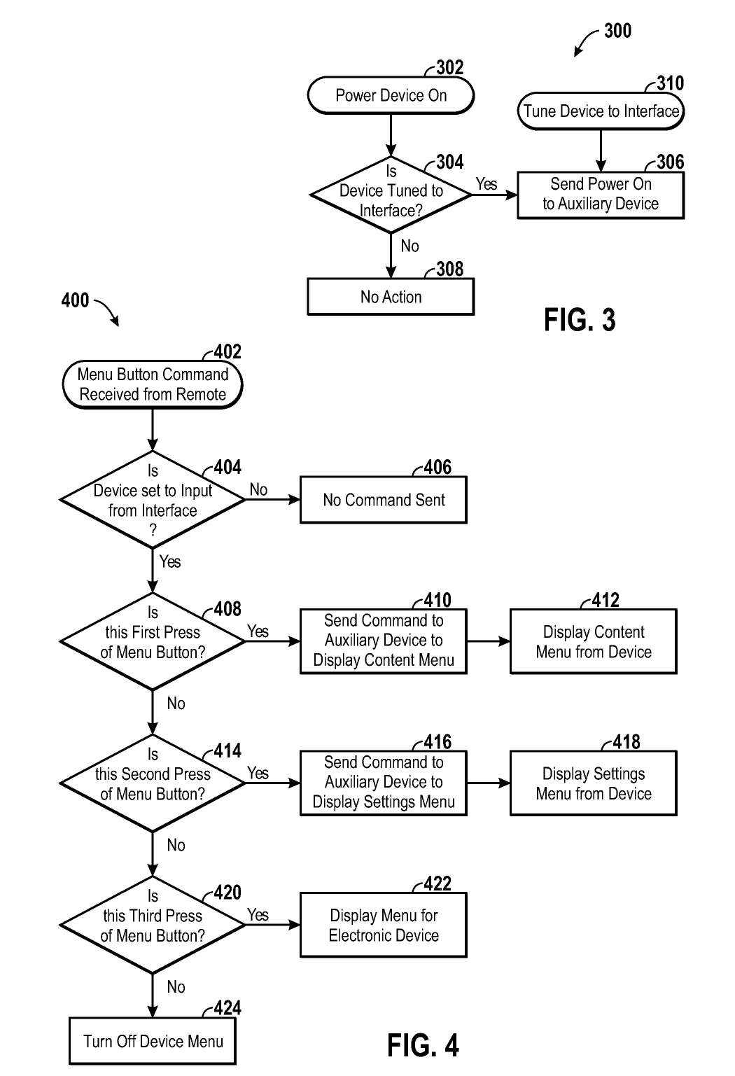

As set forth above, the electronic device 100 may be configured to allow a user to access content stored on the auxiliary device 102 and to play that content using appropriate subsystems of the electronic device 100. The electronic device 100 may generate appropriate commands for the auxiliary device from commands entered from the remote control 114 when the interface 104 is selected as the input. Presently contemplated embodiments showing how the electronic device 100 may use the commands from the remote control 114 to control the auxiliary device 102 are discussed below with reference to FIGS. 3, 4, and 5.

FIG. 3 is a process flow diagram illustrating a method 300 that may be used for powering on an auxiliary device 102. The method 300 begins at block 302, when the electronic device 100 is powered on.

At block 304, a determination is made about whether the interface 104, e.g., an HDMI, is selected as the input for the electronic device 100. If the interface 104 is selected, in block 306, the electronic device 100 sends a power on command to the auxiliary device 102. If the interface 104 is not selected, no further action is taken and the method 300 ends at block 308. If the electronic device 100 is already powered on, and then the interface 104 is selected as the input, as shown in block 310, the method 300 will also send a power on command to the auxiliary unit 102.

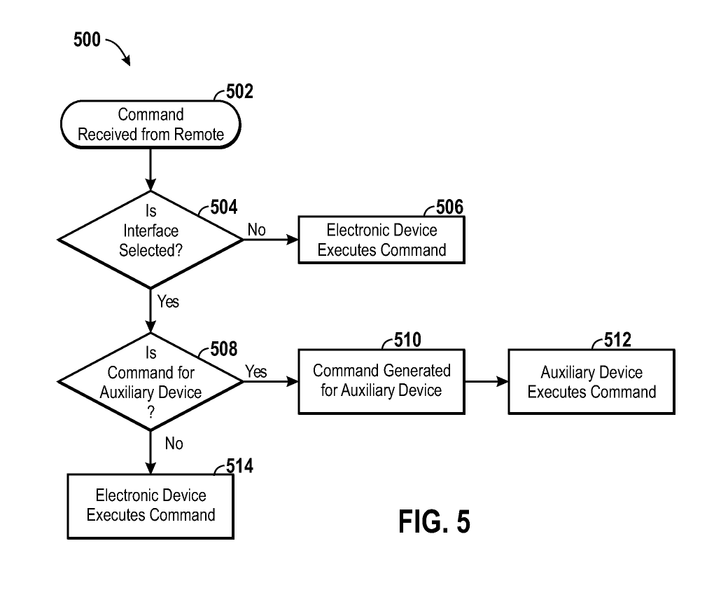

The user interface of the electronic device 100 may automatically determine whether to generate a command to instruct the auxiliary device 102 to send a menu for display on the display subsystem 152. This may be performed, for example, by following the method 400 detailed in the block diagram of FIG. 4. The method 400 begins in block 402, when the user presses the menu button 128 located on the remote control 114. In block 404, the method 400 determines whether the interface 104 to the auxiliary device 102 is selected as the input to the electronic device 100. If the interface 104 is not selected, the method 400 ends at block 406. Although no command may be sent to the auxiliary device 102 in this case, the electronic device 100 may still process the command, e.g., displaying a menu for the electronic device 100.

If the interface 104 is selected as the input to the electronic device 100, in block 408, the method 400 may determine if this is the first press of the menu button 128. If so, in block 410, the method 400 may send a command to the auxiliary device 102 to generate a media signal which may be used to display a content menu. In block 412, the method 400 may display the content menu on the display subsystem 152 of the electronic device 100. The content menu may be completely transferred to the electronic device 100 and stored in the memory 158 for display. In one presently contemplated embodiment, the command to display the content menu for the auxiliary device 102 is a CEC compliant command sent to the auxiliary device 102 through an HDMI.

If the method 400 determines that this is not the first press of the menu button 128, in block 414, the process determines whether this is the second press of the menu button 128. If so, in block 416, the method 400 may send a command to the auxiliary device 102 to generate a media signal representing a settings menu. In block 418, the method 400 may display the settings menu on the display subsystem 152 of the electronic device 100. The settings menu may be completely transferred to the electronic device 100 and stored in the memory 158 for display. In one presently contemplated embodiment, the command to display the settings menu for the auxiliary device 102 is a CEC compliant command sent to the auxiliary device 102 through an HDMI.

If the method 400 determines that this is not the second press of the menu button 128, in block 420, the process determines whether this is the third press of the menu button 128. If so, in block 422, the method 400 may display a menu for the electronic device 100 on the display subsystem 152 of the electronic device 100. The displayed menu may be a settings menu, an input selection menu, a control menu, or a master menu that allows for the selection of submenus.

If the method 400 determines that this is not the third press of the menu button 128, in block 424, the process ends by turning off all menu displays. Accordingly, the display may revert to whatever media signal was previously displayed, for example, the play of content from the auxiliary device 102.

As discussed above, FIG. 4 illustrates the use of a process to automatically send a menu command from an electronic device 100 to an auxiliary device 102, e.g., a CEC compliant command sent through an HDMI. However, any command entered on the remote control 114 that may be appropriate for the auxiliary device 102 may be used for the generation of an appropriate command for the auxiliary device 102 by the electronic device 100. This is discussed in further detail with respect to FIG. 5.

In FIG. 5, a method 500 is used to send a command to the auxiliary device 102 from the electronic device 100 based on a command received from the remote control 114. The method 500 starts in block 502 with the user pressing a button on the remote control 114 to send a command to the electronic device 100. In block 504, the method 500 determines if the interface 104 is selected as the input for the electronic device 100. If the interface 104 is not selected, in block 506 the method 500 ends with the execution of the command by the electronic device 506.

If the interface 104 is selected, in block 508 the method 500 determines whether the command may be more appropriately executed by the auxiliary device 102. The determination of the appropriate unit for execution of a command may be performed by various techniques, such as a table listing device commands that should be sent to a particular type of auxiliary device. For example, if the auxiliary device 102 is a DVD player, and the electronic device 100 is a television, such a table may indicate that commands such as play, stop play, rewind, fast forward, and pause, among others, should be executed by the auxiliary device 102. If the command should be executed by the auxiliary device, in block 510 the process generates an appropriate corresponding command for the auxiliary device 102 and transfers that command to the auxiliary device 102 through the interface 104. The command generated may be a CEC compliant command sent to the auxiliary device 102 over an HDMI. In block 512 the auxiliary device 102 may execute the command generated by the method 500.

If the command is not one that may more appropriately be executed by the auxiliary device 102, in block 514, the process ends with the execution of the command by the electronic device 100. For example, if the auxiliary device 102 is a DVD player, and the electronic device 100 is a television, such commands may include, for example, volume up, volume down, channel up, channel down, and mute, among others.

While the present disclosure may be susceptible to various modifications and alternative forms, specific embodiments have been shown by way of example in the drawings and will be described in detail herein. However, it should be understood that the present disclosure is not intended to be limited to the particular forms disclosed. Rather, the present disclosure is to cover all modifications, equivalents and alternatives falling within the spirit and scope of the present disclosure as defined by the following appended claims.

What is claimed is:

1. An electronic device, comprising:
a media subsystem configured to play a media signal;
an interface configured to place the electronic device in communication with an auxiliary device;
a remote receiver configured to receive a command from a remote control; and
a user interface that is configured to incrementally display a different operational screen with each press of a menu button on the remote control when the electronic device is in communication with the auxiliary device.

2. The electronic device of claim 1, wherein the operational screen comprises a content menu for the auxiliary device.

3. The electronic device of claim 1, wherein the operational screen comprises a settings menu for the auxiliary device.

4. The electronic device of claim 1, wherein the operational screen comprises a settings menu for the electronic device.

5. The electronic device of claim 1, wherein the operational screen comprises content from the auxiliary device.

6. The electronic device of claim 1, wherein the media subsystem comprises an audio subsystem, a display subsystem or both.

7. The electronic device of claim 1, wherein the interface comprises a High-Definition Multimedia Interface (HDMI) that is adapted to transfer the media signal from the auxiliary device to the electronic device, and to transfer a consumer electronics control (CEC) compliant command from the electronic device to the auxiliary device.

8. The electronic device of claim 1, wherein the user interface is configured to analyze the command and send a corresponding command to the auxiliary device.

9. The electronic device of claim 8, wherein the corresponding command comprises a power-on command sent to the auxiliary device.

10. The electronic device of claim 8, wherein the corresponding command comprises play, stop, fast forward, rewind, pause, channel up, channel down, or any combinations thereof.

11. The electronic device of claim 1, wherein the media signal comprises a picture, an audio signal, or a video signal, or any combination thereof.

12. A method for displaying menus on a display subsystem of an electronic device, comprising:
identifying an auxiliary device as an input to an electronic device;
determining whether the electronic device is in communication with the auxiliary device, and if so:
analyzing a command the electronic device receives from a remote control; and
incrementally displaying a different menu with each press of a menu button on the remote control.

13. The method of claim 12, comprising:
displaying a content menu from the auxiliary device on the display subsystem upon a first, a second, or a subsequent press of the menu button.

14. The method of claim 12, comprising:
displaying a settings menu from the auxiliary device on the display subsystem upon a first, a second, or a subsequent press of the menu button.

15. The method of claim 12, comprising:
displaying a menu from the electronic device on the display subsystem upon a first, a second, or a subsequent press of the menu button.

16. The method of claim 12, comprising:
turning off all menu displays upon a subsequent press of the menu button.

17. The method of claim 12, comprising:
sending a command to power on the auxiliary device when the auxiliary device is selected as the input to the electronic device.

18. The method of claim 12, comprising:
generating a consumer electronics control (CEC) compliant command for the auxiliary device in response to the command the electronic device receives from the remote control; and
transmitting the CEC compliant command to the auxiliary device through a High-Definition Multimedia Interface (HDMI).

19. An electronic device comprising:
means for detecting the press of a menu button on a remote control;
means for detecting whether an auxiliary device is in communication with the electronic device; and
means for sequentially displaying a different menu screen upon each press of the menu button, when the electronic device is in communication with the auxiliary device.

20. The electronic device of claim 19, wherein the menu screen comprises a content menu from the auxiliary device, a settings menu from the auxiliary device, a settings menu from the electronic device, or a content screen from the auxiliary device.
